(19) United States
(12) Patent Application Publication
(10) Pub. No.: US 2014/0295320 A1
(43) Pub. Date: Oct. 2, 2014

(54) PLATINUM-RHODIUM NANO-DENDRITIC ALLOY AND DIRECT METHANOL FUEL CELL INCLUDING THE SAME

(71) Applicant: INTELLECTUAL DISCOVERY CO., LTD., Seoul (KR)

(72) Inventors: Kyung-Won PARK, Seoul (KR); Young-Woo LEE, Seoul (KR); Si-Jin KIM, Seoul (KR); Da-Hee KWAK, Daejeon (KR)

(73) Assignee: INTELLECTUAL DISCOVERY CO., LTD., Seoul (KR)

(21) Appl. No.: 14/228,675

(22) Filed: Mar. 28, 2014

(30) Foreign Application Priority Data
Mar. 28, 2013 (KR) 10-2013-0033855

(51) Int. Cl. H01M 4/92; H01M 8/10

(52) U.S. Cl. CPC H01M 4/921; H01M 8/1011
USPC 429/506; 502/339

(57) ABSTRACT

A platinum-rhodium nano-dendritic alloy includes a plurality of first structure having a round shape and a second structure connecting the plurality of first structures and having a thin bridge shape, wherein the first and second structures containing platinum and rhodium homogeneously distributed therein.

### CROSS-REFERENCE TO RELATED APPLICATION

This application claims priority to and the benefit of Korean Patent Application No. 10-2013-0033855 filed in the Korean Intellectual Property Office on Mar. 28, 2013, the entire contents of which are incorporated herein by reference.

### BACKGROUND OF THE INVENTION

(a) Field of the Invention

A platinum-rhodium nano-dendritic alloy and a direct methanol fuel cell including the same are provided.

(b) Description of the Related Art

A fuel cell is a cell directly converting chemical energy generated by oxidation of fuel such as hydrogen, methanol, natural gas, or the like, into electrical energy. A representative fuel cell is a hydrogen-oxygen fuel cell, and in the hydrogen-oxygen fuel cell, hydrogen gas is supplied to an anode as fuel, and oxygen gas is supplied to a cathode as an oxidant. At the anode of the fuel cell, hydrogen gas is oxidized to thereby form protons and electrons, and at the cathode thereof, oxygen gas is reduced together with protons to thereby form water.

Among the fuel cells, a direct methanol fuel cell to which methanol is directly supplied as fuel may be miniaturized due to a simple fuel supply system. However, since the direct methanol fuel cell oxidizes methanol, a large amount of a platinum catalyst is required. Since this platinum catalyst is expensive, in order to decrease a cost, the development of a catalyst capable of decreasing a content of platinum has been demanded.

The above information disclosed in this Background section is only for enhancement of understanding of the background of the invention and therefore it may contain information that does not form the prior art that is already known in this country to a person of ordinary skill in the art.

### SUMMARY OF THE INVENTION

In an embodiment, a platinum-rhodium nano-dendritic alloy and a direct methanol fuel cell including the same may increase a catalytic activity while decreasing a content of platinum.

An exemplary embodiment provides a platinum-rhodium nano-dendritic alloy including a plurality of first structures having a round shape and a second structure connecting the plurality of first structures and having a thin bridge shape, wherein platinum and rhodium are homogeneously distributed in the first and second structures.

An atomic ratio of platinum and rhodium may be approximately 70%:30% to 80%:20%.

An exemplary embodiment provides a direct methanol fuel cell including an anode supplied with methanol, a cathode facing the anode, and a separator positioned between the anode and the cathode, wherein a support containing a platinum-rhodium nano-dendritic alloy is positioned on the anode.

An exemplary embodiment provides a manufacturing method of a platinum-rhodium nano-dendritic alloy including putting a platinum salt solution, a rhodium salt solution, a reducing agent solution, and distilled water in a reactor to form a mixed solution and stirring the mixed solution at room temperature, adding a surfactant to the mixed solution, and raising a temperature of the reactor and then stirring the mixed solution.

The reducing agent may be ascorbic acid.

The surfactant may be polyvinyl pyrrolidone (PVP).

The platinum-rhodium nano-dendritic alloy according to an exemplary embodiment may increase the catalytic activity while decreasing the content of platinum.

### BRIEF DESCRIPTION OF THE DRAWINGS

FIG. 1 is a transmission electron microscope (TEM) photograph of a platinum-rhodium nano-dendritic alloy according to an exemplary embodiment of the present invention.

FIG. 2 is a transmission electron microscope (TEM) photograph of a platinum-rhodium nano-dendritic alloy according to an exemplary embodiment of the present invention.

FIG. 3 is an energy-dispersive X-ray spectroscopy (EDX) graph of the platinum-rhodium nano-dendritic alloy according to the exemplary embodiment of the present invention.

FIG. 4 is a line-profile graph of the platinum-rhodium nano-dendritic alloy according to an exemplary embodiment of the present invention.

FIG. 5 is a transmission electron microscope (TEM) photograph of a carbon support on which the platinum-rhodium nano-dendritic alloy according to an exemplary embodiment of the present invention is supported.

FIG. 6 is a transmission electron microscope (TEM) photograph of a carbon support on which the platinum-rhodium nano-dendritic alloy according to an exemplary embodiment of the present invention is supported.

FIG. 7 is an X-ray diffraction (XRD) graph of the carbon support on which the platinum-rhodium nano-dendritic alloy according to an exemplary embodiment of the present invention is supported.

FIG. 8 is a graph of a methanol oxidation reaction of the carbon support on which the platinum-rhodium nano-dendritic alloy according to an exemplary embodiment of the present invention is supported.

FIG. 9 is a view showing a direct methanol fuel cell according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification. In addition, the detailed description of the widely known technologies will be omitted.

Hereinafter, a platinum-rhodium nano-dendritic alloy according to an exemplary embodiment of the present invention and a direct methanol fuel cell including the same will be described.

According to an exemplary embodiment of the present invention, a specific surface area may be increased by designing a dendritic alloy in which platinum and rhodium are homogenously distributed, and a methanol oxidation reaction may be maximized by controlling a surface of a catalyst to intensify a catalytic activity.

For example, a terminal portion of a Pt—Rh nanoparticle has a round structure. Due to a tendency to decrease surface energy during a growth process of metal particles, a crystal structure having an entirely round shape is shown. In a single crystal structure, several round structures and a thin bridge shaped structure connecting the round structures to each other are formed. In addition, the Pt—Rh nanoparticle is an alloy in which Pt atoms and Rh atoms are homogeneously mixed with each other. An approximate ratio of the PT atom and the Rh atom may be about 70%:30% to 80%:20%.

The direct methanol fuel cell may be applied to a portable power supply, or the like, and the platinum-rhodium nano-dendritic alloy according to an exemplary embodiment of the present invention may be used as a catalyst of the direct methanol fuel cell.

In addition, since the platinum-rhodium nano-dendritic alloy according to an exemplary embodiment of the present invention may increase the catalytic activity while decreasing a use amount of platinum, the methanol oxidation reaction of the direct methanol fuel cell requiring a large amount of catalyst may be easily carried out.

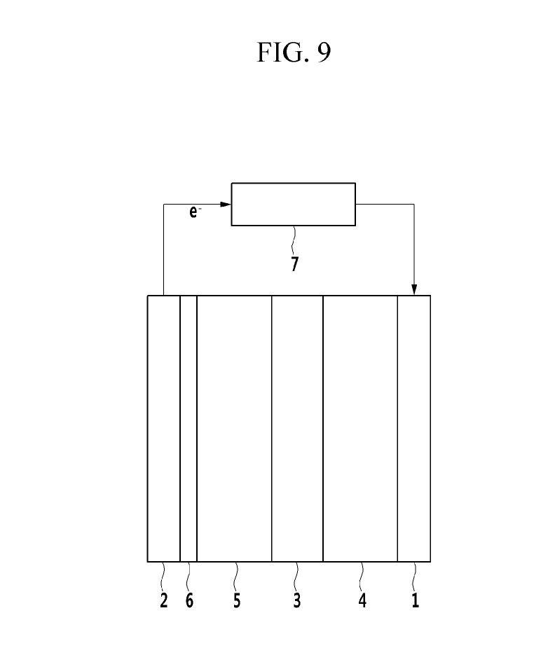

Referring to FIG. 9, the direct methanol fuel cell includes a cathode 1, an anode 2 facing the cathode 1, a separator 3 positioned between the cathode 1 and the anode 2, an oxidant supply chamber 4 positioned between the cathode 1 and the separator 3, a fuel supply chamber 5 positioned between the anode 2 and the separator 3, and a catalyst support 6 positioned on the anode.

The oxidant may be oxygen gas, air, or the like, and the fuel may be methanol. The separator may be a proton-exchange membrane electrode assembly.

The catalyst support 6 may be a support containing the platinum-rhodium nano-dendritic alloy according to an exemplary embodiment of the present invention.

A manufacturing method of the platinum-rhodium nano-dendritic alloy according to an exemplary embodiment of the present invention will be described.

First, a Pt salt and an Rh salt may be added to distilled water, respectively, thereby preparing a Pt salt solution and an Rh salt solution. Here, each of the salts may be a raw material forming the final Pt—Rh alloy particle. For example, as the Pt salt, H₂PtCl₆ may be used, and as the Rh salt, RhCl₃ may be used. Further, about 10 mL of each of the Pt salt solution (about 10 mM) and the Rh salt solution (about 10 mM) may be prepared.

In addition, a reducing agent reducing Pt and Rh ions to Pt and Rh atoms is prepared. For example, the reducing agent may be ascorbic acid, and about 40 mL of ascorbic acid (about 20 mM) may be prepared.

After putting the Pt salt solution, the Rh salt solution, the reducing agent solution, and distilled water into a reactor, the mixed solution may be continuously stirred at room temperature. For example, after putting about 1 mL of a Pt solution, about 1 mL of a Rh solution, about 5 mL of ascorbic acid solution, and about 3.5 mL of distilled water into the reactor, the mixed solution may be continuously stirred at room temperature so that all of the added materials may be uniformly mixed with each other.

In addition, after stirring, a surfactant may be added to the mixed solution. For example, about 0.01 g of polyvinyl pyrrolidone (PVP) at a concentration of about 1 g/L may be added to the mixed solution.

After adding the surfactant, the mixed solution may be continuously stirred at room temperature again, such that the surfactant may be completely dissolved.

After raising a temperature of the reactor, the mixed solution may be continuously stirred, such that a nano-dendritic alloy in which platinum and rhodium are homogeneously distributed may be prepared. For example, after putting the reactor in a constant temperature water bath maintained at about 80° C., the mixed solution is continuously stirred for about 2 hours, such that the reaction may be carried out. As the reaction time of the mixed solution passes, a color of the mixed solution may be changed from a yellow color to a black color, which indicates that the Pt—Rh nano-dendritic alloy is formed.

The synthesized Pt—Rh nano-dendritic alloy may be subjected to a washing process for removing impurities. For example, in order to remove other impurities such as the remaining additives, the surfactant, and the like, the washing with ethanol (three times) and distilled water (one time) through centrifugation may be performed.

In addition, in order to support the synthesized Pt—Rh nano-dendritic alloy on the support, after synthesizing the synthesized Pt—Rh nano-dendritic alloy with the support to put a resultant into distilled water, the mixed solution is stirred. For example, after putting a Pt—Rh alloy catalyst obtained by calculating about 20 wt % Pt—Rh alloy/C to synthesize the Pt—Rh nano-dendritic alloy with a carbon support (Vulcan XC-72R) into distilled water, the mixed solution is stirred.

In order to improve support of the catalyst, the mixed solution may be stirred under acidic atmosphere, subjected to sonicated, and then stirred again. For example, after controlling a pH at about 2 using sulfuric acid, the mixed solution may be stirred at room temperature for about 30 minutes, sonicated for about 30 minutes, and then stirred for about 24 hours.

The prepared Pt—Rh alloy and Pt—Rh alloy support may be washed in order to remove impurities. For example, in order to remove other impurities such as the remaining additives, the surfactant, and the like, the washing with ethanol (three times) and distilled water (one time) through centrifugation may be performed.

Hereinafter, the present invention will be described in detail with reference to Examples, but the following Examples are only examples of the present invention, and the present invention is not limited to the following Examples.

### Preparation Example 1

About 10 mL of H₂PtCl₆ solution (about 10 mM) and about 10 mL of RhCl₃ solution (about 10 mM) were prepared. About 40 mL of ascorbic acid solution (about 20 mM) was prepared. After putting about 1 mL of Pt solution, about 1 mL of Rh solution, about 5 mL of ascorbic acid solution, and about 3.5 mL of distilled water into a reactor, the mixed solution was continuously stirred at room temperature. Then, about 0.01 g of PVP at a concentration of about 1 g/L to the mixed solution, and then the mixed solution was continuously stirred again at room temperature. After putting the reactor in a constant temperature water bath maintained at about 80° C., the mixed solution is continuously stirred for about 2 hours, such that a reaction was carried out. As the reaction time of the mixed solution was passed, a color of the mixed solution was changed from a yellow color to a black, and a Pt—Rh nano-dendritic alloy was formed. Next, the washing with ethanol (three times) and with distilled water (one time) was performed through centrifugation.

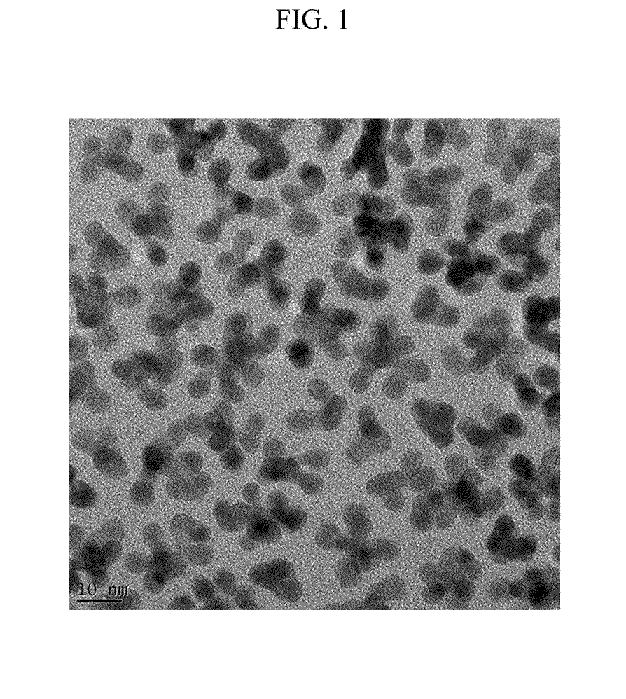

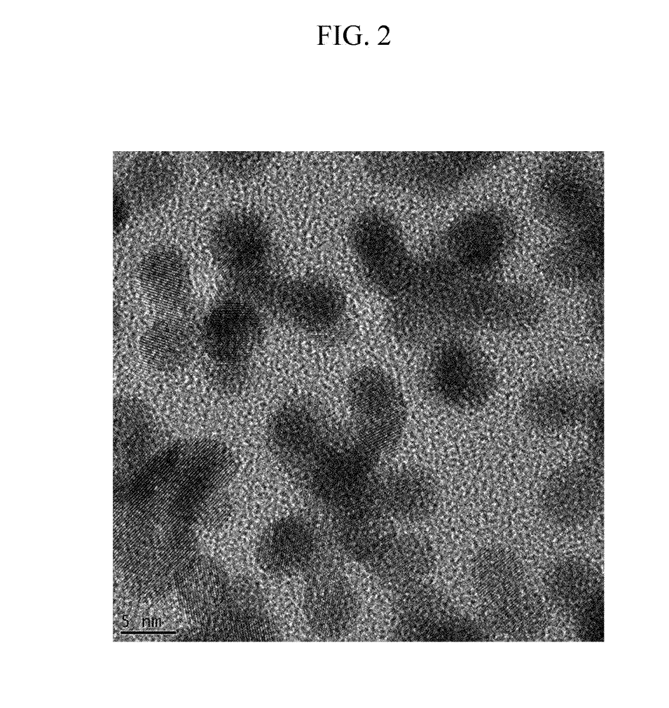

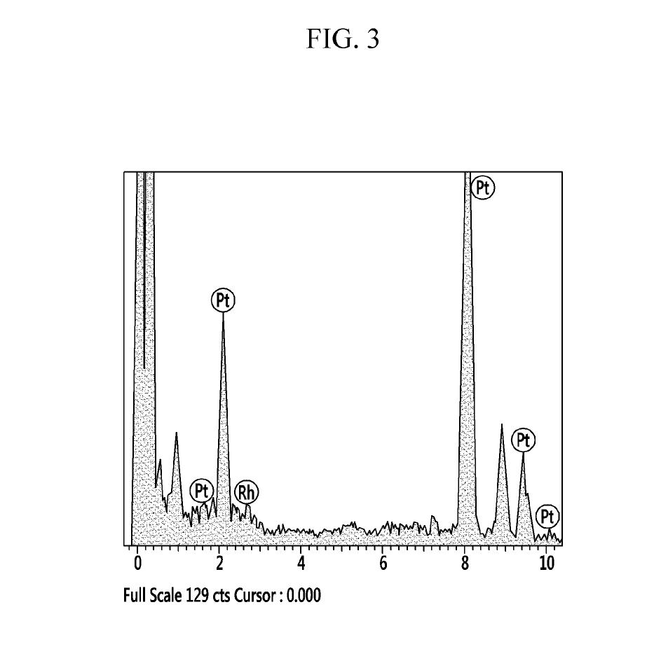

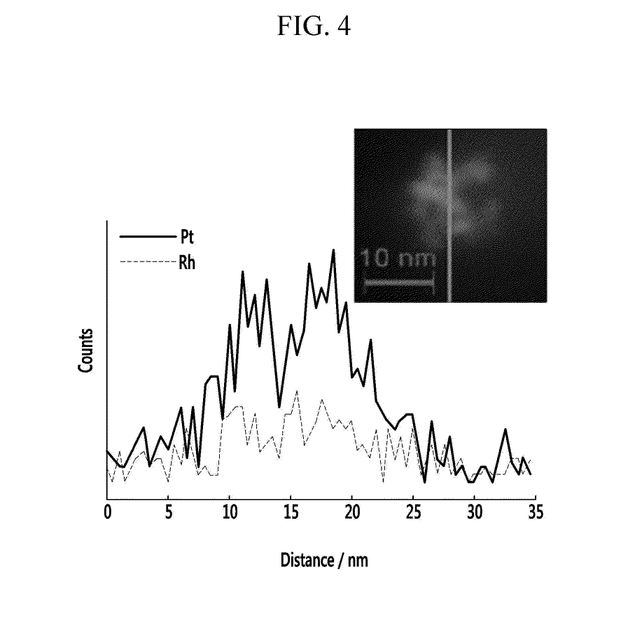

TEM photographs of the prepared Pt—Rh nano-dendritic alloy were shown in FIGS. 1 and 2. In addition, an EDX graph and a line-profile graph of the prepared Pt—Rh nano-dendritic alloy were shown in FIGS. 3 and 4, respectively.

As a result of TEM analysis, it may be appreciated that the prepared Pt—Rh nanoparticle had a dendritic structure. In addition, as a result of EDX analysis, in the case of the synthesized Pt—Rh nanoparticle, an atomic ratio of Pt and Rh was about 76.4%: 23.6%. As a result of line-profile analysis, it may be appreciated that a single Pt—Rh nanoparticle formed an alloy in which Pt and Rh were homogeneously mixed in atomic state.

### Preparation Example 2

After putting a Pt—Rh alloy catalyst obtained by calculating about 20 wt % Pt—Rh alloy/C with respect to the Pt—Rh nano-dendritic alloy prepared in Preparation Example 1 and synthesizing the Pt—Rh nano-dendritic alloy with a carbon support (Vulcan XC-72R) into distilled water, the mixed solution was stirred. Thereafter, after controlling a pH of the mixed solution at about 2 using sulfuric acid, the mixed solution was stirred at room temperature for about 30 minutes, subjected to sonication for about 30 minutes, and then stirred again for about 24 hours. Next, the washing with ethanol (three times) and with distilled water (one time) was performed through centrifugation.

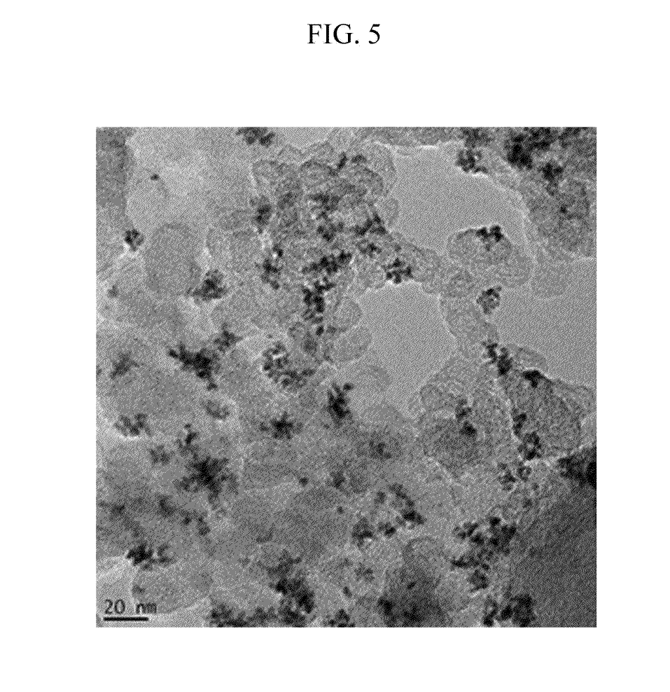

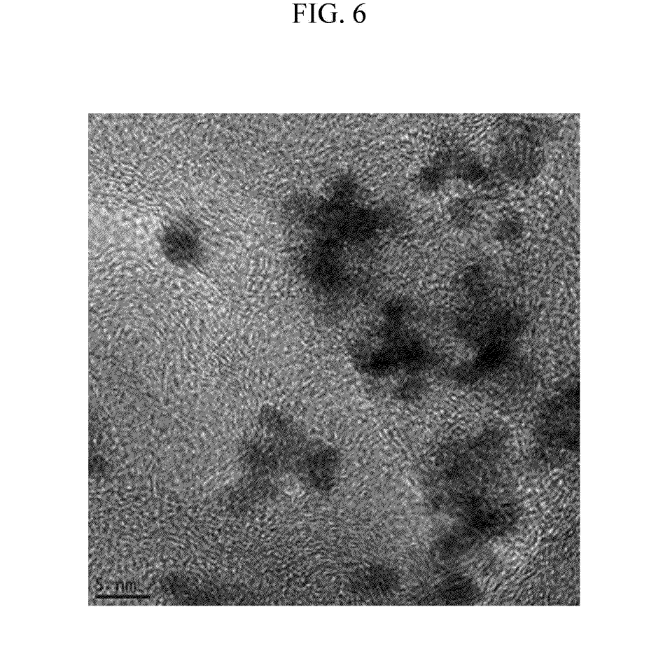

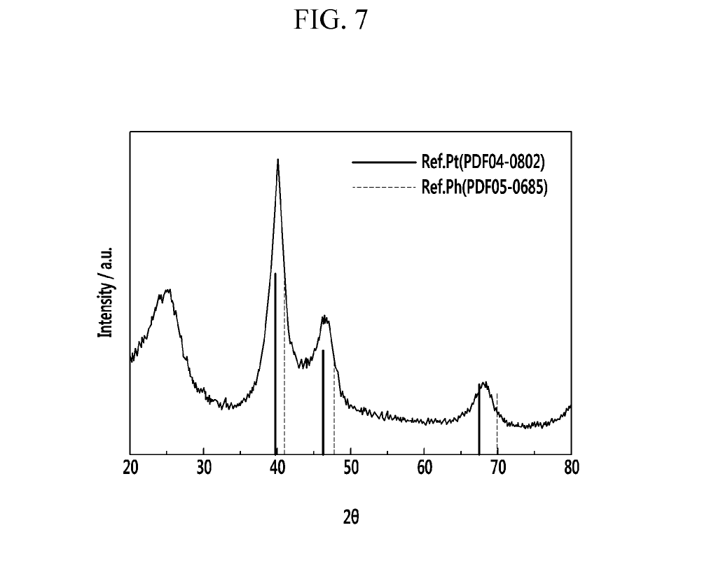

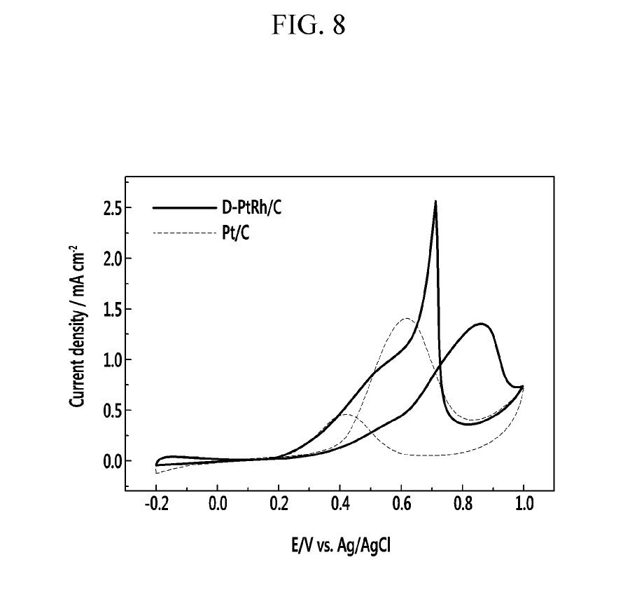

TEM photographs of the prepared Pt—Rh nano-dendritic alloy/C were shown in FIGS. 5 and 6. In addition, an XRD graph of the prepared Pt—Rh nano-dendritic alloy/C and a graph of a methanol oxidation reaction were shown in FIGS. 7 and 8, respectively.

Referring to FIGS. 5 and 6, it may be appreciated that the synthesized Pt—Rh nano-dendritic alloy was highly distributed on carbon black.

In the XRD graph of FIG. 7, X-ray diffraction (XRD) analysis was performed in a range of about 20 degrees to about 80 degrees. In the synthesized Pt—Rh nano-dendritic alloy/C, a position of main peak for each facet was shown in an intermediate region of Pt and Rh of Joint Committee on Powder Diffraction Standards (JCPDS), such that it may be appreciated that Pt and Rh were homogeneously mixed in the Pt—Rh nano-dendritic alloy. In addition, a peak of the carbon support in the same region was shown in the vicinity of about 25 degrees.

Further, a composition of the Pt—Rh alloy was analyzed using Vegard's law (dPtRh=XdPt+(1−X)dRh) through the XRD analysis. When calculating the composition of the Pt—Rh alloy for 220 facet, Pt was about 71.55%, and Rh was about 28.45%, which was similar to the EDX result of the TEM.

In the graph of the methanol oxidation reaction of FIG. 8, a change in redox current density in aqueous perchloric acid and methanol according to a change in voltage for the catalyst was measured by a general electrochemical method (three electrode cell). Here, catalytic activities in the presence of an aqueous solution in which perchloric acid (0.1 M) and methanol (2.0 M) were mixed were compared with respect to the prepared working electrode, a platinum wire counter electrode, and an Ag/AgCl reference electrode.

As shown in FIG. 8, the prepared Pt—Rh nano-dendritic alloy/C had high oxidation current density and low onset potential as compared to a commercialized Pt/C catalyst. Therefore, since the catalytic activity of the prepared Pt—Rh nano-dendritic alloy/C was larger than that of the commercialized Pt/C catalyst, oxidation potential for fuel such as hydrogen, methanol, or the like, may be further intensified. Price competitiveness of the direct methanol fuel cell may be improved in terms that in the case of the methanol oxidation reaction, even though the same amount of catalyst was used, the amount of Pt was decreased in a state in which the maximum current density was entirely similar. Further, since the direct methanol fuel cell has rapid on-set potential, the entire cell performance may be improved.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A platinum-rhodium nano-dendritic alloy comprising:
a plurality of first structures having a round shape; and
a second structure connecting the plurality of first structures to each other and having a thin bridge shape,
wherein platinum and rhodium are homogeneously distributed in the first and second structures.

2. The platinum-rhodium nano-dendritic alloy of claim 1, wherein:
an atomic ratio of platinum and rhodium is 70%:30% to 80%:20%.

3. A direct methanol fuel cell comprising:
an anode supplied with methanol;
a cathode facing the anode; and
a separator positioned between the anode and the cathode,
a support containing a platinum-rhodium nano-dendritic alloy is positioned on the anode,
the platinum-rhodium nano-dendritic alloy including a plurality of first structure having a round shape and a second structure connecting the plurality of first structures and having a thin bridge shape, and
platinum and rhodium being homogeneously distributed in the first and second structures.

4. The direct methanol fuel cell of claim 3, wherein:
an atomic ratio of platinum and rhodium is 70%:30% to 80%:20%.

5. A manufacturing method of a platinum-rhodium nano-dendritic alloy, the method comprising:
putting a platinum salt solution, a rhodium salt solution, a reducing agent solution, and distilled water in a reactor to form a mixed solution and stirring the mixed solution at room temperature;
adding a surfactant to the mixed solution; and
raising a temperature of the reactor and then stirring the mixed solution.

6. The method of claim 5, wherein:
the reducing agent is ascorbic acid.

7. The method of claim 5, wherein:
the surfactant is polyvinyl pyrrolidone (PVP).
